(19) United States
(12) Patent Application Publication
(10) Pub. No.: US 2025/0170007 A1
(43) Pub. Date: May 29, 2025

(54) DISSECTION STATION AND INSTALLATION

(71) Applicant: STELLENBOSCH UNIVERSITY, Stellenbosch (ZA)

(72) Inventors: Paul Nicholaas Bester PRETORIUS, Stellenbosch (ZA); Karin BAATJES, Stellenbosch (ZA)

(21) Appl. No.: 18/840,777

(22) PCT Filed: Feb. 23, 2023
(86) PCT No.: PCT/ZA2023/050011

§ 371 Date: Aug. 22, 2024

(30) Foreign Application Priority Data
Feb. 23, 2022 (GB) 2202495.4

(51) Int. Cl. A61G 13/00; A61G 13/10

(52) U.S. Cl. CPC A61G 13/0027; A61G 13/102; A61G 2203/76

(57) ABSTRACT

Disclosed herein is a dissection station for a cadaver. The station includes a tray having an arrangement of ventilation openings which allow a passage of fluid from the tray and an elongate form configured to support the cadaver. The station further includes an elongate bath disposed below the tray and configured to support the tray; a drainage system including a drainage outflow from the bath; and a gas extraction system including an exhaust duct from the bath. Further disclosed herein is an installation of a dissection station which is configured to force gas from a ceiling gas insertion mechanism toward the tray and through the ventilation arrangement to the bath and from the bath through an exhaust duct extension.

### CROSS-REFERENCE TO RELATED APPLICATIONS

This application claims priority from United Kingdom patent application number 2202495.4 filed on 23 Feb. 2022, which is incorporated by reference herein.

### FIELD OF THE INVENTION

The present disclosure relates to a station and an installation adapted for dissection, particularly the dissection of cadavers.

### BACKGROUND TO THE INVENTION

Anatomical dissections of cadavers are performed atop dissection tables, which are metal tables capable of supporting the length and weight of a cadaver at a height comfortable for dissection. When used in an educational setting, a cadaver is placed atop the dissection table prior to the start of the lesson and kept moist through the application of a wetting agent or embalming fluid, which slows putrefaction. Once dissection is performed, the body and extracted tissue are collected for cremation or burial. Each lesson needing a fresh cadaver requires significant preparation before and after dissection, and extensive use of wetting agents may expose persons to potentially harmful fumes and chemicals.

The Applicant therefore believes there is scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a dissection station for a cadaver comprising: a tray having an elongate form configured to support the cadaver, the tray including an arrangement of ventilation openings which allow a passage of fluid from the tray and the tray including an angled portion disposed at an edge portion of the tray with the angled portion including an array of ventilation openings angled towards a flat portion of the tray configured to support the cadaver; an elongate bath disposed below the tray; a drainage system including a drainage outflow from the bath; and an exhaust duct for gas extraction from the bath.

The tray may include angled portions along each elongate side of the tray and the array of ventilation openings may extend along the length of each of the angled portions. The tray may include a lip arrangement along each elongate side of the tray for engagement with a top edge of the elongate bath.

The bath may be configured to store a second cadaver. The bath may include a base surface angled for drainage to the drainage outflow. The bath may be configured to support the tray.

The drainage system may include a valve to selectively prevent drainage outflow from the bath. The drainage system may include a basin with a drainage outflow from the basin passing through the bath. The drainage outflow may include a secondary drainage inlet from the bath. The drainage system may include a secondary valve to selectively prevent drainage outflow from the basin.

The tray may include two or more independently removable portions. The arrangement of ventilation openings may include openings at the perimeter of the tray.

Further features of the dissection station provide for a storage container for storage of extracted parts of the cadaver, the storage container being removably attached to the dissection station.

The dissection station may include a gas extraction system for extracting gas from the exhaust duct and configured to draw gas vertically from the bath away from the station. The basin and the exhaust duct may be disposed at an end of the station.

Components of the dissection station including one or more of: the tray, the basin, the exhaust duct, the gas extraction system and the drainage system may be configured to be dismantled to facilitate cleaning.

The dissection station may include a table arrangement supporting the bath and having a central support arrangement a distance inboard of the sides of the bath to provide clear access to the sides of the bath. The dissection station may have a wheel arrangement for moving the station.

In accordance with a further aspect of the invention there is provided a dissection installation comprising: a dissection station according to the above aspects; a ceiling gas extraction mechanism having a downward extending exhaust duct extension provided from a ceiling, the exhaust duct extension being attachable to the exhaust duct of the dissection station; and a ceiling gas insertion mechanism disposed above the dissection station, wherein the installation is configured to force gas from the ceiling gas insertion mechanism toward the tray and through the array of ventilation openings to the bath and from the bath through the exhaust duct extension.

Further features of the dissection installation provide for a gas emission and suction system configured to force gas toward the tray and through the array of ventilation openings to the bath and from the bath through the exhaust duct extension at a rate which results in the complete exchange of gas within the room after a predetermined time interval.

The dissection installation may include a gas emission and suction system configured to force gas toward the tray and through the array of ventilation openings to the bath and from the bath through the exhaust duct extension at a rate which, when combined with a predetermined number of installations within a room, results in the complete exchange of gas within the room after a predetermined time interval. The predetermined time interval may be less than or equal to one twenty-fourth of an hour.

Embodiments of the invention will now be described, by way of example only, with reference to the accompanying drawings.

### BRIEF DESCRIPTION OF THE DRAWINGS

In the drawings:

FIG. 1 illustrates an exemplary dissection station according to aspects of the present disclosure;

FIG. 2 is a sectional side view of the embodiment of FIG. 1 including a first and second cadaver;

FIG. 3 is a sectional side view of the embodiment of FIG. 1;

FIG. 4 is a front view of the embodiment of FIG. 1;

FIG. 5 is a sectional front view of the embodiment of FIG. 1;

FIG. 6 is a side view of the embodiment of FIG. 1 including drainage bucket;

FIG. 7 is detail sectional view of the drainage system included in the embodiment of FIG. 1;

FIG. 8 is a three-dimensional view of the embodiment of FIG. 1 including a storage container with a lid in a closed position;

FIG. 9 is a three-dimensional view of the embodiment of FIG. 1 including a storage container with a lid in an open position;

FIG. 10 illustrates an exemplary installation according to aspects of the present disclosure;

FIG. 11 is an exploded view of the embodiment of FIG. 1; and

FIG. 12 illustrates another exemplary embodiment of a dissection station according to aspects of the present disclosure.

### DETAILED DESCRIPTION WITH REFERENCE TO THE DRAWINGS

Aspects of the present disclosure provide for a ventilated dissection station for a cadaver and an installation thereof. The dissection station may find particular use when installed in rooms where persons are exposed to multiple cadavers, for example in dissection halls and cadaver preparation areas which may accommodate for example upwards of 32 tables each having a cadaver.

Each station includes a tray having an arrangement of openings which allow fluid to pass from the tray. The fluid openings are generally disposed on a flat portion of the tray that supports a cadaver and may be disposed around the periphery of the flat portion. The fluid maybe a liquid, such as an embalming fluid or wetting agent (for example formalin). The fluid may also be a gas, such as fumes emitted from the embalming fluid and/or cadaver, or air.

The tray also includes an angled portion disposed at an edge portion of the tray in which a ventilation arrangement in the form of an array of ventilation openings is provided with the ventilation openings angled towards the flat portion of the tray that supports the cadaver. The array of ventilation openings are configured to vent fluid, particularly gas. The angle of the ventilation openings aids in the capture of gas from a cadaver supported on the tray. The fluid openings and the ventilation openings may be provided in parallel along the elongate edges of the tray. The angle of the ventilation openings compared to the fluid openings results in the ventilation openings venting mainly gas, and possibly some fluid, whilst the fluid openings drain the majority of the liquid. The gas insertion and extraction described below aids in the flow of the gas and fluid through the openings.

The tray may be in an elongate form configured to support the length of the cadaver. The tray may be particularly configured to support the weight of a cadaver, which may approximate 120 to 150 kilograms. The arrangement of fluid openings and ventilation openings may be provided along the perimeter of the tray so as to allow the passage of fluid from the tray without compromising the strength of the tray. In some embodiments, only side placement of openings with fewer openings is preferable to enable the tray to support the weight of heavier bodies. It is envisaged that the trays may be interchangeable to select a tray suitable for a given weight of a cadaver.

Each station further includes an elongate bath. The bath is disposed below the tray and configured to support the tray. The bath may be of similar length to the tray. In some embodiments, the elongate bath may be trough shaped. The bath may be of a suitable depth and length to accommodate a second cadaver, which may be stored underneath the first cadaver. The tray may include a lip arrangement along each elongate side of the tray for engagement with a top edge of the elongate bath.

A drainage system including a drainage outflow from the bath. A gas extraction system including an exhaust duct from the bath may also be included at each station. The bath may be shaped to facilitate the movement of fluid in a desired direction. For example, the bath may include a base surface angled for drainage to the drainage outflow. Alternatively or in addition, the bath may be shaped to facilitate the movement of gas toward the exhaust duct.

An installation of a dissection station may include a ceiling gas extraction mechanism having a downward extending exhaust duct extension attachable to the dissection station and provided from a ceiling. The installation may also include a ceiling gas insertion mechanism disposed above the dissection station.

When in use, gas may be forced from the ceiling gas insertion mechanism toward the tray and through the ventilation arrangement to the bath, and from the bath through the exhaust duct extension. The installation may further include a gas emission and suction system, such as an air circulation system, configured to force gas toward the tray and through the ventilation arrangement to the bath and from the bath through the exhaust duct extension at a rate which results in the complete exchange of gas within the room after a predetermined time interval. In other words, the amount of gas directed toward the tray and the amount removed through the exhaust duct extension may result in all the gas being exchanged within the room after a given time interval. The size of the room and/or the number of stations within the room may be considered when determining the desired time interval.

The interval may be determined such that the rate of exchange is sufficient to render embalming fluid fumes undetectable or minimally detectable by persons within the room. For example, the installation may be configured to exchange gas at a rate which, when combined with a predetermined number of installations within a room, results in the complete exchange of gas within a room 24 times per hour (i.e. every 2.5 minutes or one twenty-fourth of an hour).

Aspects of the present disclosure may therefore provide a station or plurality of stations which may be used without embalming fluid vapours or other related smells being detectable by persons working in those areas. The removal of fumes may also provide a safer dissection environment and may be effective enough to remove fumes even in the case of standing fluid due to intentionally blocked drainage during dissection and/or the storage of multiple cadavers within a station. For example, the drainage system may include a valve to selectively prevent drainage outflow from the bath, allowing stations to be set up away from installed drainage systems, and/or the bath may be configured to store a second cadaver within the bath, which may reduce the amount of time required for preparing a dissection hall and the required amount of embalming fluid.

Further features, such as a basin for storing organs and a storage container for removed tissue may also be provided. The station may further be configured to be movable and/or have modular parts (such as a two-part tray and/or a removable basin) to allow for easier setup and clean up.

In some embodiments, the station may include a table arrangement supporting the bath. The bath may be elevated and/or have a central support arrangement a distance inboard of the sides of the bath to facilitate leg clearance and/or to provide clear access to the sides of the bath.

FIGS. 1 to 9 illustrate an example embodiment of a dissection station (100), in which like references between the figures refer to like features. As best seen in the three-dimensional view of FIG. 1, the embodiment of a dissection station (100) includes a table arrangement (102) supporting a bath (104). The supports (103) of the table arrangement are reinforced with a number of longitudinal crossbars or central support (105). The positioning of the central support may allow persons to sit comfortably while performing a dissection.

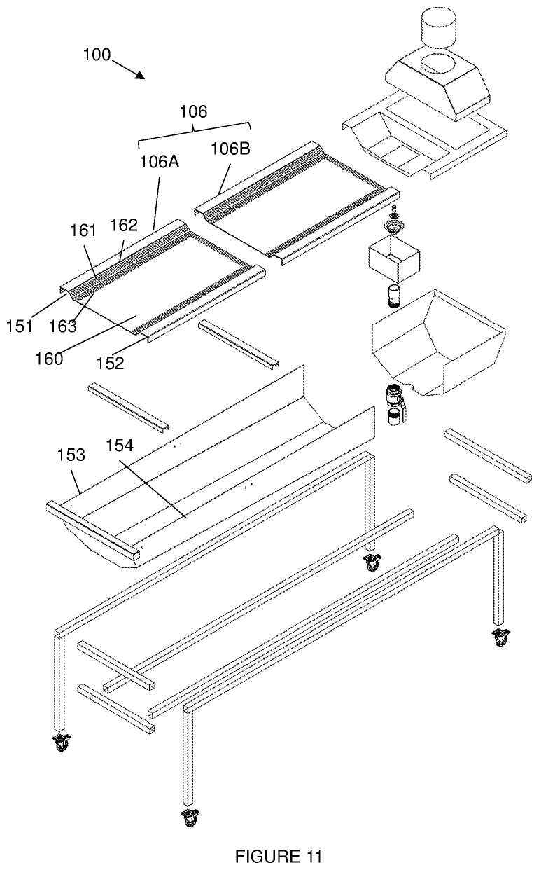

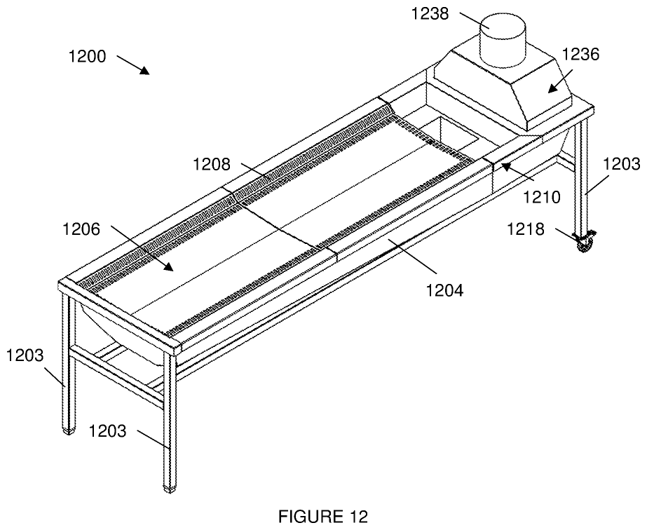

The dissection station includes a bath (104) covered with a tray (106). The tray (106) may have an elongate form to accommodate a cadaver (202) during dissection. The tray (106) includes two independently removable portions (106A, 106B) to reduce the weight and facilitate carrying of the tray when a cadaver is placed on top. As shown in FIG. 11, an angled portion (161) may extend on each elongate side of the tray (106) from the flat surface (160) of the tray (106). The tray (106) may include a lip arrangement (151, 152) along each elongate side of the tray for engagement with a top edge (153, 154) of the elongate bath. The lip arrangement (151, 152) may be formed with the angled portion (161) and may extend along each side of the tray (106). As shown, the tray (106) may two or more independently removable portions (106A. 106B) which each have the angled portions (161).

An arrangement (108) of fluid and ventilation openings is provided on the tray (106) which allow a passage of fluid from the tray (106). The fluid may be a liquid, such as embalming fluid, or a gas such as air mixed with fumes from the cadaver and or embalming fluid. The arrangement (108) of fluid and ventilation openings may include openings at the perimeter of the tray (106), at the perimeter of a portion (106A, 106B) of the tray (106), or any other suitable area. The number and placement of the fluid and ventilation openings may be determined by the maximum weight the tray must support.

Referring again to FIG. 11, the ventilation openings (162) may be provided in the angled portions (161) adjacent the edges of the flat portion (160) and may particularly vent gas emitted from the cadaver on supported on the tray (106). The fluid openings (163) may be provided around the periphery and in the flat portion (160) of the tray to drain fluid mainly in the form of liquid. Some fluid openings (163) may be provided across a central portion of the flat portion, for example, where independent sections (106A, 106B) of the tray (106) meet.

Although a tray which is fully removable in portions is illustrated, it should be appreciated that other forms of the tray may be suitable, such as a tray hinged to the bath, trays with more or less than two portions, a tray which is slidably removable from the bath, or the like.

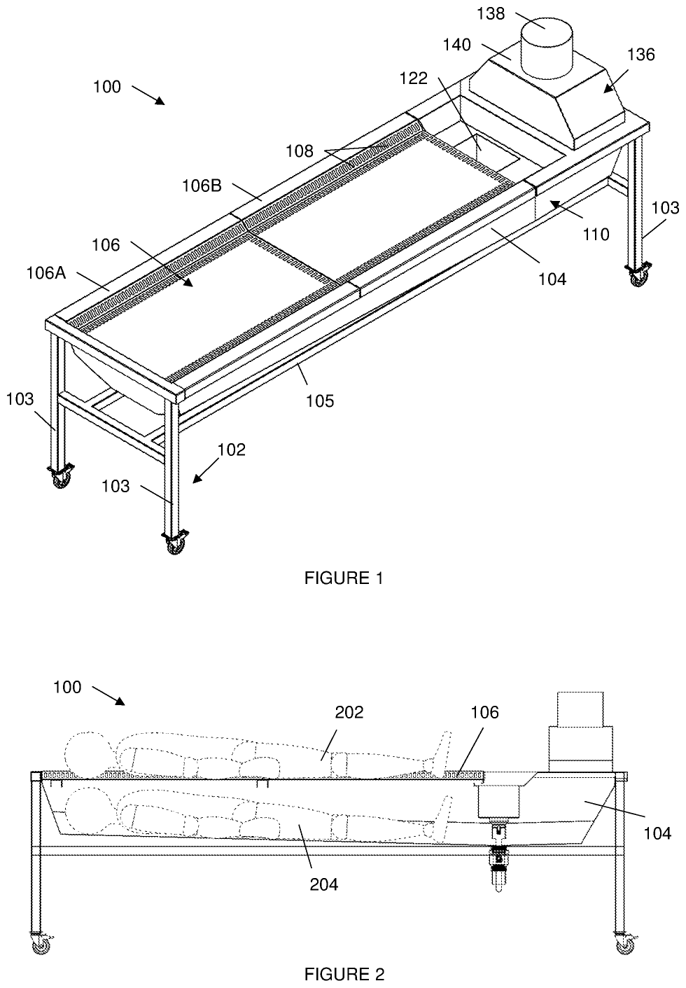

The bath (104) is disposed below the tray (106) and may be configured to support the tray (106). The bath (104) may be elongate and may further be configured to store a second cadaver (204). FIG. 2 is a sectional side view of the embodiment (100) of a dissection station according to FIG. 1 which includes a first (202) and second (204) cadaver. The first cadaver (202) is positioned atop the tray (106), and the second cadaver (204) is positioned below the first cadaver (202) and inside the bath (104). Allowing the cadavers (202, 204) to be positioned in this way may reduce the amount of set up time and wetting agent required in, for example, an educational setting in which multiple lessons each requiring a fresh cadaver have been scheduled proximate one another. The aforementioned configuration may allow for the first lesson to be set up with the first cadaver (202) disposed on top of the tray (106) and the second lesson to be provisionally set up with the second cadaver (204) stored within the bath (104). Excess wetting agent poured onto the first cadaver (202) may also wet the second cadaver (204) as the agent flows through the arrangement (108) of ventilation openings, thus reducing the amount of agent required to preserve both cadavers (202, 204). In some embodiments, the ventilation openings on the tray (106) may be arranged to optimize the flow of the wetting agent from atop the tray (106) toward the second cadaver (204). The bath (104) may also be used to store tissue or organs following the same principle.

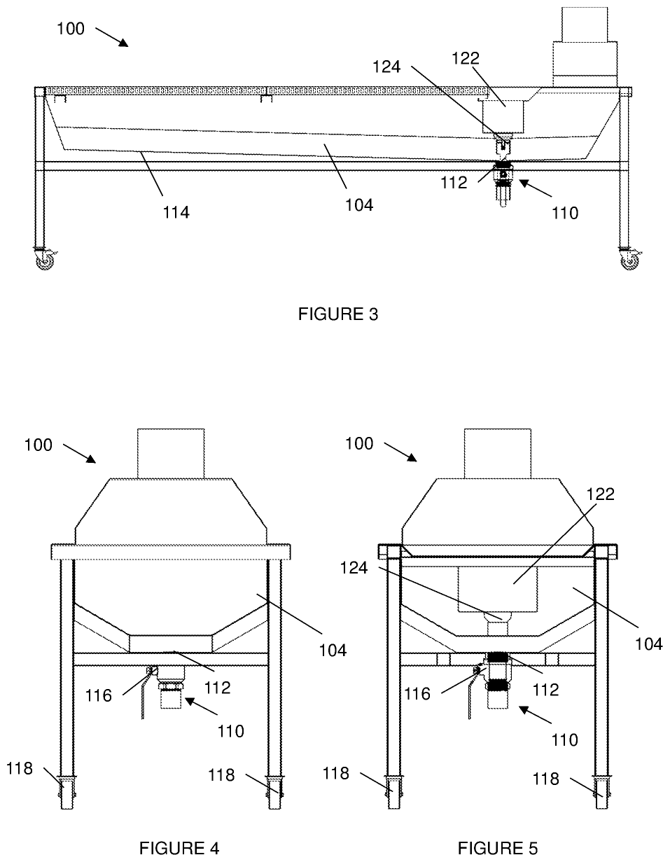

FIG. 3 is a sectional side view of the embodiment (100) of the dissection station according to FIG. 1 without cadavers present. As seen in FIG. 3, the dissection station also includes a drainage system (110) which includes a drainage outflow (112) from the bath (104). The bath (104) may be shaped or configured to facilitate the draining of liquid toward the drainage outflow (112). For example, the bath (104) may include a base surface (114) angled for drainage to the drainage outflow (112). The drainage outflow (112) may be positioned in the base surface (114) of the bath (104).

As best seen in FIGS. 4 and 5, the drainage system (110) of the dissection station (100) may further include a valve (116) to selectively prevent drainage through the drainage outflow (112) from the bath (104). FIG. 4 is a front view of the embodiment (100) of a dissection station according to FIG. 1 which clearly illustrates the valve (116), and FIG. 5 is a sectional front view of the same embodiment (100) which illustrates the valve (116) within the drainage system (110). The valve (116) may be a manual valve and may be any suitable valve. The valve (116) may be located under the bath (104) at a position which is easily accessible. Including a bath (104) with a drainage system (110) having a valve (116) which can prevent draining through the drainage outflow (112) may allow the dissection station to be moved or positioned away from permanent drainage installations, for example at the center of a room or in a room with no installed drains, and the position of the dissection station within a room need not be fixed. The station may, for example, further include a wheel arrangement (118) or the like for moving the station.

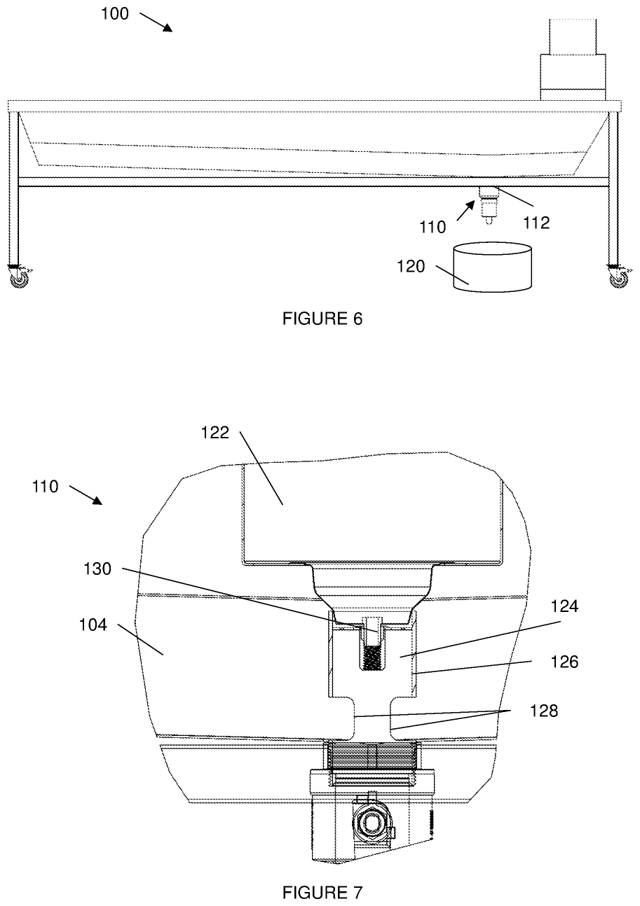

FIG. 6 is a side view of the embodiment (100) of a dissection station according to FIG. 1 which includes a container or bucket (120) for collecting fluid from the drainage outflow (112). The bucket (120) may be placed under the drainage system (110) after a dissection to receive the collected fluid from within the bath, to be reused or disposed as is deemed fit. Since the valve may prevent drainage outflow, the bucket (120) need not be present during dissection, when it (120) may be susceptible to being knocked over by persons moving around the dissection station. The vapours of the extra fluids may also be minimalized due to the configuration of the station.

Returning to FIG. 1, the embodiment (100) of a dissection station includes a drainage system (110) which includes a basin (122). The basin (122) may be disposed at an end of the station. The basin (122) may resemble a small sink or a recessed drain and may be used, for example, for storing organs while a person is working on a cadaver. The basin (122) can also be seen in the sectional views of FIGS. 3 and 5. The basin (122) may include a drainage outflow (124) from the basin (122) passing through the bath (104).

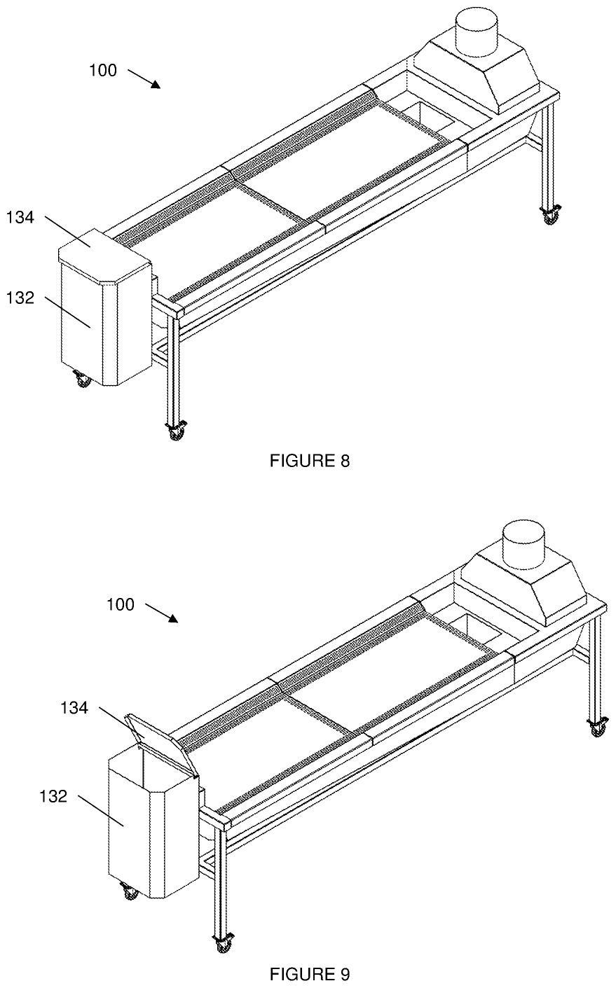

FIG. 7 is a detail sectional view of the drainage system (110) including the basin (122) with a drainage outflow (124) from the basin (122). The drainage outflow (124) may include a downpipe (126) including a secondary drainage inlet (128) from the bath (104). The secondary drainage inlet (128) may be formed from cut-out portions in the side of the downpipe (126) at the level of the base of the bath (104). The downpipe (126) may terminate in the drainage outflow (112) from the bath (104). Closure of the valve (116) may prevent fluid from draining from the bath (104) and also from the basin (122).

The basin may include a secondary valve (130) or be configured to receive a secondary valve. The secondary valve (130) may selectively prevent drainage outflow from the basin itself. The secondary valve (130) may be a manual valve and may be any suitable valve, plug or stopper. For example, the secondary valve (130) may be a sink plug, basket strainer or stopper commonly used in conventional domestic sinks. This enables the contents of the basin (122) to be held captive while continuing to allow the fluids of the bath (104) to drain. At other times, the secondary valve (130) of the basin (122) may be opened to allow fluid to drain from the basin (122) as well as from the bath (104).

FIGS. 8 and 9 illustrate the embodiment (100) of a dissection station according to FIG. 1, including an additional storage container (132). The storage container (132) may be removably attached to the dissection station, or the storage container (132) may be fixed. The storage container (132) may be positioned at an end of the dissection station, for example at the front end of the station. The storage container (132) may include a lid (134). In some embodiments, the lid (134) may be fully removable. In other embodiments, the lid (134) may be partially removable; it ( ) may for example be hinged to the storage container (132). FIG. 8 illustrates the embodiment (100) of a dissection station according to FIG. 1, including the storage container (132) with a hinged lid (134) in a closed position. FIG. 9 illustrates the same with the lid (134) in an open position. The storage container (132) may be useable for storing extracted parts of the cadaver (for example removed cadaver tissue) until the cadaver is buried or cremated.

Returning again to FIG. 1, the dissection station also includes a gas extraction system (136) including an exhaust duct (138) from the bath (104). The gas extraction system (136) may include a hood (140) or other suitable formation which directs gas from the bath (104) through the exhaust duct (138). The gas extraction system (136) may cover a portion of the bath (104). The gas extraction system (136) and the exhaust duct (138) may be disposed at an end of the station. The gas extraction system (136) may facilitate an exchange of gas surrounding the station, allowing for harmful and/or unpleasant fumes to be removed from near the station.

The exhaust duct (138) may be attachable or removably attachable to an exhaust duct extension of a main ventilation system. For example, the exhaust duct extension may have an inner diameter which approximates the outer diameter of the exhaust duct (138), allowing the extension to be placed onto the exhaust duct (138) and held by friction, a clamp, or, if the exhaust duct extension is disposed from the ceiling, gravity.

The detachable exhaust duct (138), when combined with other features like the valve (116) and wheel arrangement (118), may allow the station to be easily moved. Having a movable dissection station with an extraction system that can be easily detached from the main ventilation system means that the entire station with a cadaver may be transported from a cadaver preparation area, for example, to dissection halls or a cadaver storage area without significantly shifting the cadaver, while still providing gas exchange when stationary in each area. The station may, for example be unhooked from a main ventilation system in a cadaver preparation area and then attached to the main ventilation system in dissection hall.

The dissection station may further be configured to be dismantled to facilitate cleaning. For example, the basin (122), gas extraction system (136), and/or drainage system (110) may be removable from the station. Having a basin (122) which is removable from the bath (104), for example, may allow the basin and bath to be fully cleaned by facilitating access to difficult-to-reach portions, or allow cleaning of the basin (122) by submerging the basin (122) in a large sink or the like.

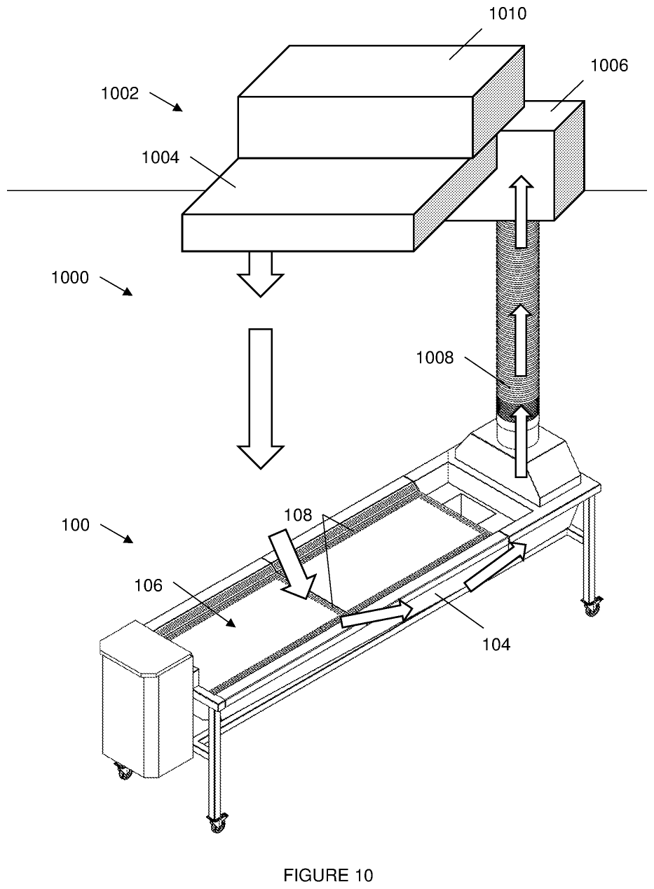

Aspects of the present disclosure further provide for an installation configured to facilitate an exchange of gas surrounding the station. FIG. 10 illustrates the dissection station (100) according to FIG. 1 when it is included in an installation (1000). An installation includes a dissection station (100) attached to a main ventilation system (1002) which includes a ceiling gas insertion mechanism (1004) and a gas extraction mechanism (1006). The ceiling gas insertion mechanism (1004) is in the form of a downwardly facing vent disposed above the dissection station (100) and is configured to force gas toward the tray (106) of the dissection station (100), causing gas to move through the arrangement (108) of angled ventilation openings (162) to the bath (104). From the bath (104), the gas goes through the exhaust duct (138) of the station's gas extraction system (136). An exhaust duct extension (1008) attachable to the exhaust duct (138) may be provided from a ceiling to direct gas from the exhaust duct (138) toward the ceiling gas extraction mechanism (1006), which relocates the gas outside of the room or area including the station (100). The exhaust duct extension (1008) may be configured to draw gas vertically from the bath (104) away from the station (100). The large arrows of FIG. 10 illustrate the direction of the gas movement in an installation (1000).

The installation (1000) may further include a gas emission and suction system (1010) configured to force gas toward the tray and through the ventilation arrangement to the bath and from the bath through the exhaust duct extension at a rate which results in the complete exchange of gas within the room after a predetermined time interval. The interval may be chosen such that the exchange is sufficient to render harmful and/or unpleasant fumes undetectable or minimally detectable by persons near the station (for example, the interval may be in the order of an hour). The installation (1000) may be configured to exchange gas at a rate which results in the complete exchange of gas by the end of the time interval. In some embodiments, other installations may be taken into account. For example, the gas emission and suction system may be configured to force gas toward the tray and through the ventilation arrangement to the bath and from the bath through the exhaust duct extension at a rate which, when combined with a predetermined number of installations within a room, results in the complete exchange of gas within the room after the predetermined time interval.

FIG. 11 is an exploded view of the embodiment (100) of a dissection station according to FIG. 1, which illustrates the various components comprising each feature which may be manufactured and assembled into a dissection station. Components of the station may be manufactured from any suitable metal, for example, stainless steel.

Although aspects of the present disclosure have been described primarily through a single embodiment within the drawings, it should be appreciated that the illustrations are not limiting and that other embodiments may be suitable. For example, FIG. 12 illustrates a second embodiment (1200) having a tray (1206) with an elongate form configured to support a cadaver, an elongate bath (1204) disposed below the tray (1206) and configured to support the tray (1206), a drainage system (1210) including a drainage outflow from the bath (1204); and a gas extraction system (1236) including an exhaust duct (1238) from the bath (1204). The tray (1206) includes an arrangement (1208) of ventilation openings which allow a passage of fluid from the tray (1206). The openings of the arrangement (1208) are arranged in a different configuration than the embodiment of FIG. 1 without a central arrangement of fluid openings. The embodiment (1200) of FIG. 12 also includes a wheel arrangement (1218) with wheels on only two of four included supports (1203).

Aspects of the present disclosure therefore provide for a moveable, ventilated dissection table and installation thereof which may allow for a safer and more pleasant, efficient and organised experience when involved in the preparation, performance and clean-up of anatomical dissections, autopsies, and the like.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A dissection station for a cadaver comprising:
a tray having an elongate form configured to support a first cadaver on the tray, the tray comprising an arrangement of openings which allow a passage of fluid from the tray;
a bath disposed below the tray and configured to store a second cadaver underneath the first cadaver;
a drainage system comprising a drainage outflow from the bath and a basin, wherein the basin has a basin drainage outflow that passes through the bath and terminates in the drainage outflow from the bath; and
an exhaust duct for gas extraction from the bath.

2. The dissection station as claimed in claim 1, wherein the tray comprises angled portions along each of two elongate sides of the tray, and an array of ventilation openings extend along the length of each of the angled portions.

3. The dissection station as claimed in claim 2, wherein the tray comprises a lip arrangement along each of the elongate sides of the tray for engagement with a top edge of the bath.

4. (canceled)

5. The dissection station as claimed in claim 1, wherein the drainage system comprises a valve to selectively open or close the drainage outflow from the bath.

6. The dissection station as claimed in claim 1, wherein the basin drainage outflow comprises a downpipe that comprises a secondary drainage inlet from the bath.

7. The dissection station as claimed in claim 6, wherein the drainage system comprises a secondary valve to selectively open or close the basin drainage outflow.

8. The dissection station as claimed in claim 1, wherein the tray comprises two or more independently removable portions.

9. The dissection station as claimed in claim 1, wherein the bath comprises a base surface angled for drainage to the drainage outflow from the bath.

10. The dissection station as claimed in claim 1, comprising a storage container for storage of extracted parts of the first cadaver, the storage container being removably attached to the dissection station.

11. The dissection station as claimed in claim 1, comprising a gas extraction system for extracting gas from the exhaust duct and configured to draw gas vertically from the bath away from the station.

12. The dissection station as claimed in claim 1, wherein the basin and the exhaust duct are disposed at an end of the station.

13. The dissection station as claimed in claim 1, wherein one or more components of the station are configured to be dismantled to facilitate cleaning.

14. The dissection station as claimed in claim 1, wherein the arrangement of openings comprises openings along a perimeter of the tray.

15. The dissection station as claimed in claim 1, comprising a table arrangement supporting the bath and having a central support arrangement a distance inboard of each of two sides of the bath to provide clear access to the sides of the bath.

16. The dissection station as claimed in claim 1, wherein the station has a wheel arrangement for moving the station.

17. A dissection installation comprising:
a dissection station according to claim 1;
a ceiling gas extraction mechanism having a downward extending exhaust duct extension provided from a ceiling, the exhaust duct extension being attachable to the exhaust duct of the dissection station; and
a ceiling gas insertion mechanism disposed above the dissection station,
wherein the installation is configured to force gas from the ceiling gas insertion mechanism toward the tray and through the arrangement of openings to the bath and from the bath through the exhaust duct extension.

18. The dissection installation according to claim 17, comprising a gas emission and suction system configured to force gas toward the tray and through the arrangement of openings to the bath and from the bath through the exhaust duct extension at a rate which results in the complete exchange of gas within a room after a predetermined time interval of less than or equal to one twenty-fourth of an hour.

19. The dissection installation according to claim 17, comprising a gas emission and suction system configured to force gas toward the tray and through the arrangement of openings to the bath and from the bath through the exhaust duct extension at a rate which, when combined with a predetermined number of installations within a room, results in the complete exchange of gas within the room after a predetermined time interval of less than or equal to one twenty-fourth of an hour.

20. (canceled)
